(19) United States
(12) Patent Application Publication
(10) Pub. No.: US 2015/0043594 A1
(43) Pub. Date: Feb. 12, 2015

(54) GATEWAY APPARATUS AND MESSAGE ROUTING METHOD

(71) Applicant: Hyundai Motor Company, Seoul (KR)

(72) Inventors: Hyun Wook Kim, Seoul (KR); Byoung Wook Lee, Seoul (KR); Hyun Soo Ahn, Yongin (KR); Jeong Hun Lee, Hwaseong (KR); Soo Mi Kim, Seoul (KR)

(73) Assignee: Hyundai Motor Company, Seoul (KR)

(21) Appl. No.: 14/141,892

(22) Filed: Dec. 27, 2013

(30) Foreign Application Priority Data
Aug. 9, 2013 (KR) 10-2013-0094822

(51) Int. Cl. H04L 12/717

(52) U.S. Cl. CPC H04L 45/42
USPC 370/422

(57) ABSTRACT

A gateway apparatus and a message routing method are provided. The gateway apparatus includes: a network adaptor transmitting and receiving a message through a vehicle network or a diagnosing CAN positioned inside a vehicle; a CAN driver transferring the message received through the network adaptor; a message router routing the message transferred from the CAN driver and filtering valid data of the message; an application invoking a signal routing application to detect validity of data of each signal of the message transferred from the CAN driver and route data of a valid signal; and a CAN diagnostor processing a message of a diagnosing apparatus performing an access through the diagnosing CAN positioned inside the vehicle to control a diagnosing operation.

### CROSS-REFERENCE TO RELATED APPLICATION

This application is based on and claims priority from Korean Patent Application No. 10-2013-0094822, filed on Aug. 9, 2013 in the Korean Intellectual Property Office, the disclosure of which is incorporated herein in its entirety by reference.

### TECHNICAL FIELD

The present invention relates to a gateway apparatus and a message routing method, and more particularly, to a technology of allowing signal routing and message routing to be performed by a message received in a gateway device.

### BACKGROUND

A vehicle communication system uses a communication gateway device in order to transfer messages and signals between different communication networks. The communication gateway module has currently used a signal routing scheme of deconstructing and reconstructing a communication message and a message routing scheme of transferring the entire message to another network.

In the signal routing scheme in the network using the gateway according to the prior art, the gateway module performs signal routing on signals including invalid data. And, in the message routing scheme in the network using the gateway device according to the prior art, the gateway device performs the message routing with respects to the entirety of message including invalid data. Thus in the gateway apparatus according to the prior art, at time of processing for the routing is delayed by performing routing in respect of both valid and invalid data.

Moreover, in the routing scheme in the network using the gateway device according to the prior art, a gateway device transfers input content as it is without performing verification of separate data, inspection for security, and the like. In addition, the gateway transfers a message generated by an external input signal to internal units as it is without separately confirming the message. Therefore, a gateway apparatus is vulnerable to security at the time of routing or reprogramming the message.

### SUMMARY

Accordingly, the present invention has been made to solve the above-mentioned problems occurring in the prior art while advantages achieved by the prior art are maintained intact.

One object to be achieved by the present invention is to provide a gateway apparatus and message routing method that allows signal routing and message routing to be individually performed on a message received at a gateway apparatus.

Another object of the present invention is to provide a gateway apparatus and message routing method that is capable of satisfying a response time required for a routing message in spite of verifying validity of a message and filtering the verified message when the message is routed.

Still another object of the present invention is to provide a gateway apparatus and message routing method that is capable of enhancing security and encoding and decoding data of different hardware devices by implementing routes for authenticating a diagnosing apparatus that performs access through a diagnosing controller area network (CAN) in a vehicle and a hardware device performing access from an external source and processing data from the respective authenticated apparatuses.

In one aspect of the present invention, there is provided a gateway apparatus including: a network adaptor configured to transmit and receive a message through a vehicle network or a diagnosing CAN positioned inside a vehicle; a processor configured to receive the message received through the network adaptor, route the message transferred from the CAN driver and filter valid data within the message; to detect a validity of data of each signal of the message received by the processor and route data of a valid signal; and a process a message of a diagnosing apparatus performing access through the processor positioned inside the vehicle to control a diagnosing operation.

In another aspect of the present invention, there is provided a message routing method of a gateway apparatus, including: transmitting and receiving a message through a vehicle network or a diagnosing CAN positioned inside a vehicle; invoking a signal routing application in an application layer to detect validity of data of each signal of the message received at processor and route data of a valid signal, in the case of performing signal routing on the message received through the vehicle network; routing the message by the processor and filtering valid data of the routed message, upon performing message routing on the message received through the vehicle network; and invoking a diagnosis application in the application layer at the time of an access of a diagnosing apparatus through the diagnosing CAN positioned inside the vehicle, thereby authenticating the access of the diagnosing apparatus and processing data of the authenticated diagnosing apparatus.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a schematic configuration of a gateway apparatus according to an exemplary embodiment of the present invention;

FIG. 2 is a diagram showing a detailed module configuration of the gateway apparatus according to the exemplary embodiment of the present invention;

FIG. 3 is an illustrative diagram showing a message routing path of the gateway apparatus according to the exemplary embodiment of the present invention;

FIG. 4 is a flow chart showing a flow of a signal routing operation of a message routing method according to the exemplary embodiment of the present invention;

FIG. 5 is a flow chart showing a flow of a message routing operation of the message routing method according to the exemplary embodiment of the present invention; and

FIG. 6 is a flow chart showing a flow of an apparatus authenticating operation of the message routing method according to the exemplary embodiment of the present invention.

### DETAILED DESCRIPTION

Hereinafter, exemplary embodiments of the present invention will be described with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g. fuels derived from resources other than petroleum).

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

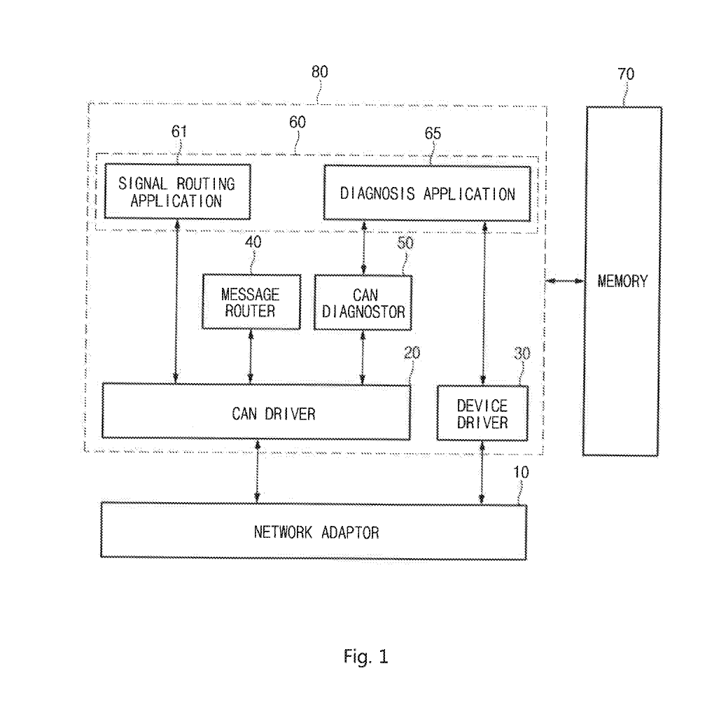

FIG. 1 is a block diagram showing a schematic configuration of a gateway apparatus according to an exemplary embodiment of the present invention. When the gateway apparatus according to the exemplary embodiment of the present invention receives a message, it performs routing on the received message and transmits the corresponding message along a transfer path of the routing message. Here, as a scheme of routing the message, a signal routing scheme and a message routing scheme may be applied. The signal routing scheme is a scheme of decomposing the corresponding message into each signal and recomposing and transferring the corresponding message. Meanwhile, the message routing scheme is a scheme of transferring the entire message.

In the present invention, the gateway apparatus of allowing each of the signal routing scheme and the message routing scheme to be applied to the received message is provided.

Referring to FIG. 1, the gateway apparatus according to the exemplary embodiment of the present invention is configured to include a network adaptor 10, a memory 70, storing thereon a controller area network (CAN) driver 20, an device driver 30, a message router 40, a CAN diagnostor 50, and an application 60 all of which may be executed by a processor 80. The network adaptor 10 transmits a message from the inside or the outside of a vehicle and supports a communication interface for transmitting a routing message. In addition, the network adaptor 10 supports a communication interface for transmitting or receiving signals to or from hardware devices positioned inside or outside the vehicle. Here, the network adaptor 10 may include a CAN communication module and include a hardware communication module supporting an access to the hardware device positioned outside the vehicle.

The CAN driver 20 converts the signal received by the network adaptor 10 into a type that may be supported by a gateway apparatus and transfers the converted signal to each unit for processing the corresponding CAN signal. Here, the CAN driver 20 transfers the corresponding message to the application 60 for signal routing of the received CAN message. Meanwhile, the CAN driver 20 transfers the corresponding message to the message router 40 for message routing of the received CAN message.

In addition, the CAN driver 20 transfers information of a diagnosing apparatus positioned inside the vehicle to the CAN diagnostor 50 in the case in which the diagnosing apparatus attempts an access through a diagnosing CAN. Herein, the information of the diagnosing apparatus may include unique information and an authentication key of the diagnosing apparatus.

The message router 40 is configured to route the message transferred from the CAN driver 20. In this case, the message router 40, does not deconstruct and reconstruct the corresponding message, but instead routes the entire message, and verifies validity of data of the corresponding message immediately before transferring the routing message. The message router 40 detects valid data among data of the corresponding message and filters out invalid data. Therefore, the message router 40 transmits the message routed by the message routing scheme to the CAN driver 20 accordingly.

The application 60 invokes and drives a signal routing application 61 in order to route the message transferred from the CAN driver 20. Here, the signal routing application 61 deconstructs the message transferred from the CAN driver 20 and analyzes the decomposed message in a signal unit to detect the validity of the corresponding data. In this case, the signal routing application 61 filters invalid data in a process of routing the transferred message.

The signal routing application 61 reconstructs the signal of the valid data and transmits the message routed by the signal routing scheme to the CAN driver 20.

The CAN diagnostor 50 is configured to transfer information regarding the diagnosing apparatus performing the access through the diagnosing CAN in the vehicle to the application 60 in order to authenticate the diagnosing apparatus. In this case, the application 60 invokes and drives a diagnosis application 65 in order to authenticate the information transferred from the CAN diagnostor 50. Here, the diagnosis application 65 diagnoses validity of the diagnosing apparatus from the unique information of the diagnosing apparatus and compares the authentication key transmitted from the diagnosing apparatus and an authentication key possessed by the corresponding gateway apparatus with each other to authenticate the access of the corresponding diagnosing apparatus. The diagnosis application 65 may permit or limit the access of the diagnosing apparatus based on a diagnosing result for the diagnosing apparatus and transmit the result to the CAN diagnostor 50. The CAN diagnostor 50 also may permit or limit the access of the diagnosing apparatus depending on the diagnosing result from the diagnosis application 65.

The device driver 30 is configured to convert the signal transmitted to the network adaptor 10 into a type that may be supported by a gateway and transfers the converted signal to each unit for processing the corresponding CAN signal, in the case in which the hardware device positioned outside the vehicle accesses the gateway apparatus. In this case, the device driver 30 may receive unique information and an authentication key of the corresponding hardware from the hardware device positioned outside the vehicle. In this case, the device driver 30 transfers the information of the corresponding hardware device to the application 60 in order to authenticate the corresponding hardware. The application 60 then invokes and drives the diagnosis application 65 in order to authenticate the information transferred from the device driver 30. Here, the diagnosis application 65 diagnoses validity of the hardware device from the unique information of the hardware device and compares the authentication key transmitted from the hardware device and the authentication key possessed by the corresponding gateway apparatus with each other to authenticate access of the corresponding hardware device. The diagnosis application 65 may permit or limit the access of the hardware device based on a diagnosing result for the hardware device and transmit the result to the device driver 30. Therefore, the device driver 30 permits or limits the access of the hardware device depending on the diagnosing result from the diagnosis application 65.

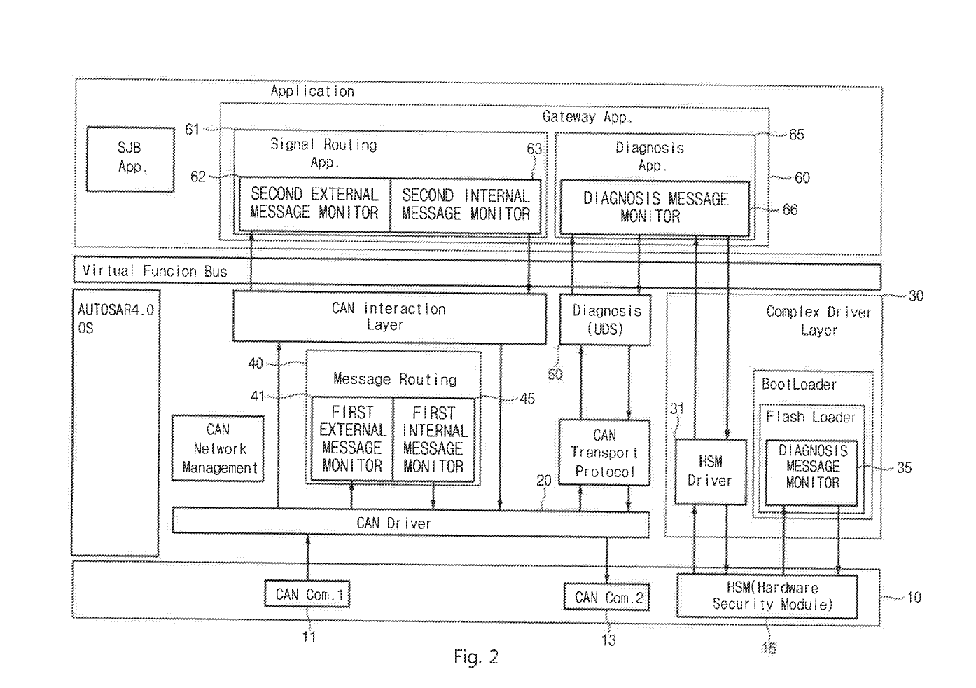

A detailed configuration of the gateway apparatus according to the exemplary embodiment of the present invention will be described with reference to FIG. 2. FIG. 2 is a diagram showing a detailed module configuration of the gateway apparatus according to the exemplary embodiment of the present invention. FIG. 2 shows the respective units shown in FIG. 1 as modules. Since functions of the respective modules are the same as those of the respective units of FIG. 1, corresponding modules will be denoted by the same reference numerals as those of FIG. 1.

As shown in FIG. 2, as a configuration of the gateway apparatus according to the exemplary embodiment of the present invention, an AutoSAR 4.0 based platform structure may be used. Here, the AutoSAR 4.0 based platform structure is a structure including an application layer, a virtual function bus layer, OS, a complex driver layer, a basic software (BSW) layer, and the like. The application layer, which is the uppermost layer, supports a gateway function and a unique function of a controller. The application layer is connected to the basic software layer and the driver layer through the virtual function bus layer to receive a resource of a microcomputer.

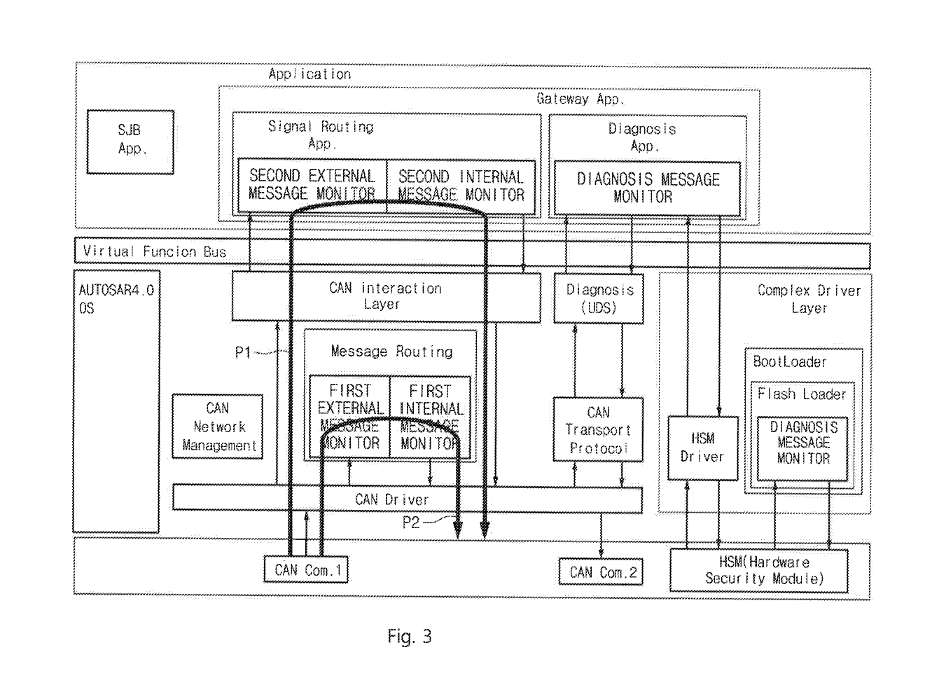

The application layer, which is a layer implementing an application 60 performing a routing and diagnosing function of the gateway apparatus, implements the signal routing application 61 and the diagnosis application 65. In the signal routing application 61, the deconstruction and the reconstruction of the signal for the signal routing is conducted therein. In this case, in the signal routing application 61, a second external message monitor 62, a second internal message monitor 63 detecting validity of a message, and the like, may be implemented. Here, the second external message monitor 62, which is executed by the processor 80 filters a communication message received from an external network of the vehicle through the CAN communication module 11, checks information and a message ID of a message of which reception is permitted. An a second internal message monitor 63 is executed by the processor to analyze the corresponding message in a signal unit in order to verify validity of data and detect the validity of the data in the signal unit. In this case, a signal routing path of the message in the gateway apparatus is ‘P1’ of FIG. 3.

Similar to the signal routing application 60, in a message routing module (ISR) 40, a first external message monitor 41 and a first internal message monitor 45 may be implemented. The first external message monitor 41 and the first internal message monitor 45 implemented in the message routing module 40 perform filtering and validity detection of the data in a message unit on messages received through an external network and an internal network of the vehicle. A message routing path of the message in the gateway apparatus is ‘P2’ of FIG. 3.

As described above, in the gateway apparatus according to the exemplary embodiment of the present invention, since the signal routing path ‘P1’ of the message and the message routing path ‘P2’ are differently implemented, respectively, and the validity detection and the filtering of the data are performed in the message unit or the signal unit at the time of routing the message, the message routing in which security is enhanced may be provided.

Meanwhile, in the diagnosis application 65 of the application layer, the diagnosis of the diagnosing apparatus or the hardware device accessing the gateway apparatus is performed. Here, in the diagnosis application 65, a diagnosing message monitor 66 performing an authentication procedure of the corresponding apparatus may be implemented. The diagnosing message monitor 66, which is a which is executed by the processor 80 processes an authentication procedure for the diagnosing apparatus or the hardware device performing access through the diagnosing CAN, and verifies validity of the corresponding apparatus and data of the corresponding apparatus. In this case, the diagnosing message monitor 66 compares the authentication key stored in the apparatus and the authentication key stored in the gateway apparatus with each other to confirm whether the apparatus is a normal apparatus.

At the time of an access of the diagnosing apparatus positioned inside the vehicle, a signal from the diagnosing apparatus is transferred to the diagnosis application 65 through a CAN transport protocol module and a diagnosis module 50.

Meanwhile, the hardware device positioned outside the vehicle may access the gateway apparatus through a hardware security module (HSM) 15 implemented in the gateway apparatus. Therefore, the hardware device positioned outside the vehicle may access the gateway apparatus through the HSM 15, and information of the hardware device positioned outside the vehicle may be transferred to the application layer through an HSM driver 30 implemented in the complex driver layer.

A flash loader module 31 for rewriting may be additionally disposed in a boot loader of the complex driver layer. In this case, even though AutoSAR 4.0 does not support a rewriting program, the rewriting may be performed using a security function of the flash loader module 31. In addition, a diagnosing message monitor 35 for encoding/decoding a diagnosing message may be additionally implemented in the flash loader module 31. The diagnosing message monitor 35 may apply an encoding/decoding algorithm supported in the gateway apparatus and execute an algorithm or provide a hardware algorithm to the microcomputer to support an encoding/decoding function for an apparatus that is not supported by the gateway apparatus.

A flow of a message routing operation of the gateway apparatus according to the exemplary embodiment of the present invention configured as described above will be described below in detail.

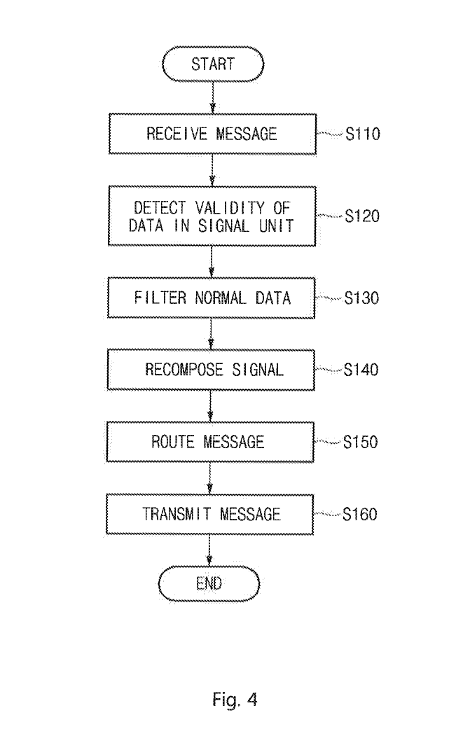

FIG. 4 is a flow chart showing a flow of a signal routing operation of a message routing method according to the exemplary embodiment of the present invention. Referring to FIG. 4, when the gateway apparatus according to the exemplary embodiment of the present invention receives an external message through the CAN module (S110), it transfers the received message to the application layer (S120). Then, the signal routing application is driven as an application (S130).

The signal routing application detects the validity of the data in the signal unit with respect to the received message (S140), filters only normal data (S150), and then reconstructs the signal (S160). Then, the signal routing application routes the corresponding message (S170) and transmits the corresponding message along the routing path (S180).

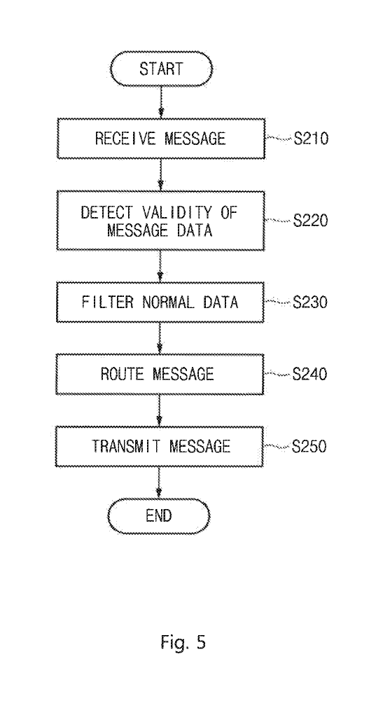

FIG. 5 is a flow chart showing a flow of a message routing operation of the message routing method according to the exemplary embodiment of the present invention. Referring to FIG. 5, when the gateway apparatus according to the exemplary embodiment of the present invention receives an external message through the CAN module (S210), it transfers the received message to the message routing module. Then, the message routing module detects the validity of the data in the message unit (S220), filters out only normal data (S230), and routes the received message along a transfer path (S240). The message routing module transmits the corresponding message along the routing path (S250).

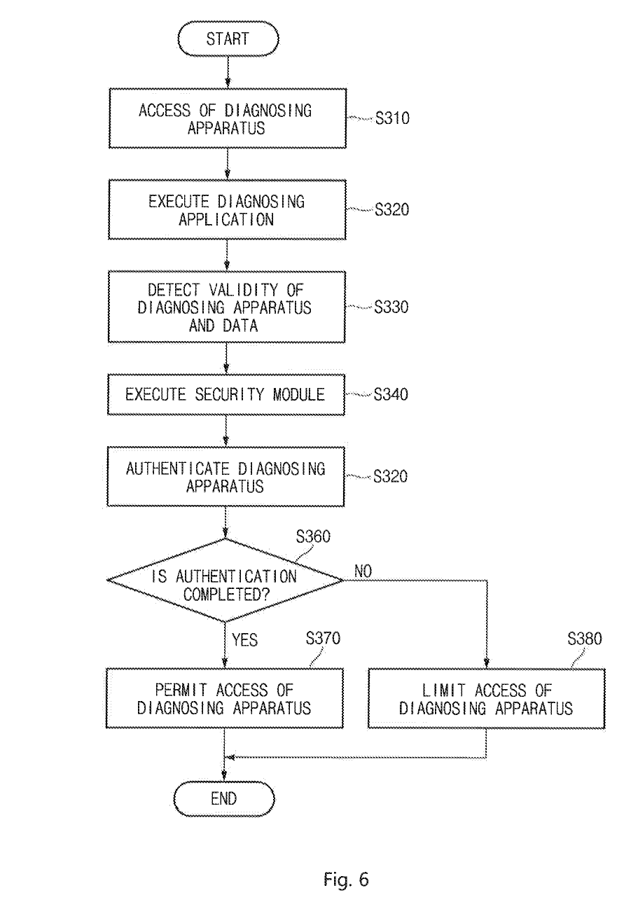

FIG. 6 is a flow chart showing a flow of an apparatus authenticating operation of the message routing method according to the exemplary embodiment of the present invention. Referring to FIG. 6, the gateway apparatus according to the exemplary embodiment of the present invention executes the diagnosis application in the application layer (S320) at the time of access of the diagnosing apparatus (S310).

The diagnosis application detects the validity of the diagnosing apparatus and the data of the diagnosing apparatus (S330), executes the security module (S340), and authenticates the diagnosing apparatus (S350). In this case, the security module compares the authentication key from the diagnosing apparatus and the authentication key stored in the gateway apparatus with each other and authenticates the corresponding diagnosing apparatus depending on whether or not the authentication keys coincide with each other.

When the authentication key from the diagnosing apparatus and the authentication key stored in the gateway apparatus coincide with each other, such that the authentication of the diagnosing apparatus is completed (S360), access by the diagnosing apparatus to the gateway apparatus is permitted (S370). Meanwhile, when the authentication fails in ‘S360’, the access of the diagnosing apparatus is limited (S380).

Although only contents associated with the diagnosing apparatus has been shown in FIG. 6, a process of permitting or limiting an access of the hardware device positioned outside the vehicle through the authentication key by detecting the validity of the hardware device positioned outside the vehicle and the data of the hardware device positioned outside the vehicle may also be performed on the hardware device positioned outside the vehicle.

In addition, the gateway apparatus may additionally perform an operation of processing or rewriting input data with respect to the diagnosing apparatus positioned inside the vehicle and the hardware device positioned outside the vehicle of which the access to the gateway apparatus is permitted in ‘S370’.

According to the exemplary embodiment of the present invention, it is possible to provide a gateway apparatus of allowing signal routing and message routing to be individually performed on a message received in a gateway, and a message routing method. In addition, it is possible to provide a gateway apparatus capable of satisfying a response time required for message routing in spite of verifying validity of a message at the time of the message routing and filtering the verified message, and a message routing method. Further, it is possible to provide a gateway apparatus capable of enhancing security and encoding/decoding data of different hardware devices by implementing routes for authenticating a diagnosing apparatus performing an access through a diagnosing controller area network (CAN) in a vehicle and a hardware apparatus performing an access from the outside and processing data from the respective authenticated apparatuses, and a message routing method.

Although the gateway apparatus and the message routing method according to the exemplary embodiment of the present invention have been described with reference to the accompanying drawings, the present invention is not limited to the exemplary embodiment and the accompanying drawings disclosed in the present specification, but may be modified without departing from the scope and spirit of the present invention.

What is claimed is:

1. A gateway apparatus comprising:
a network adaptor transmitting and receiving a message through a vehicle network or a diagnosing controller area network (CAN) positioned inside a vehicle; and
a processor configured to:
route the message received by the network adaptor and filter valid data within the message,
detect validity of data of each signal of the message received by the network adaptor and route data having a valid signal, and
process a message of a diagnosing apparatus performing an access through the diagnosing CAN positioned inside the vehicle to control a diagnosing operation.

2. The gateway apparatus according to claim 1, wherein the processor includes:
a first external message monitor detecting and filtering the valid data in a message unit on a message received through an external network of the vehicle; and
a first internal message monitor detecting and filtering the valid data in a message unit on a message received through an internal network of the vehicle.

3. The gateway apparatus according to claim 2, wherein the first external message monitor and the first internal message monitor are disposed in an interrupt processing routine of the message router and detects validity of the data and filters the data before transferring the message.

4. The gateway apparatus according to claim 1, wherein the signal routing application includes:
a second external message monitor confirming and filtering information of a message received through an external network of the vehicle and transferred from the CAN driver; and
a second internal message monitor analyzing a message received through an internal network of the vehicle and transferred from the CAN driver in a signal unit to detect validity of data of the message and recompose only a signal of valid data.

5. The gateway apparatus according to claim 1, wherein a processor invokes a diagnosis application in response to a request from the CAN diagnostor to diagnose validity of a diagnosing apparatus accessing the gateway apparatus and data of the diagnosing apparatus.

6. The gateway apparatus according to claim 5, wherein the diagnosis application includes a diagnosing message monitor filtering the message received through the diagnosing CAN positioned inside the vehicle.

7. The gateway apparatus according to claim 5, wherein the diagnosing application is configured to diagnose validity of a hardware device positioned outside the vehicle and authenticating an access of the hardware device from an authentication key of the hardware device and an authentication key stored in the gateway apparatus.

8. The gateway apparatus according to claim 7, wherein the processor is further configured to permit or limit the access of the hardware device depending on the diagnostic result from the diagnosis application at the time of an access of the hardware device.

9. The gateway apparatus according to claim 1, further comprising a flash loader invoking an encoding and decoding algorithm for a hardware device positioned outside the vehicle at the time of an access of the hardware device performing encoding and decoding in a complex driver layer.

10. The gateway apparatus according to claim 8, wherein the processor is configured to execute a device driver that is implemented in a complex driver layer.

11. A message routing method, comprising:
receiving, by a network adaptor, a message through a vehicle network or a diagnosing CAN positioned inside a vehicle;
invoking, by a processor, a signal routing application in an application layer to detect validity of data of each signal of the message transferred from a CAN driver and route data of a valid signal, in the case of performing signal routing on the message received through the vehicle network;
detecting, by a processor, validity of data of the message transferred from the CAN driver and filtering valid data to route valid of the message, in the case of performing message routing on the message received through the vehicle network; and
invoking, by the processor, a diagnosis application in the application layer to authenticate the access of the diagnosing apparatus and process data of the authenticated diagnosing apparatus at the time of an access of a diagnosing apparatus through the diagnosing CAN positioned inside the vehicle.

12. A non-transitory computer readable medium containing program instructions executed by a processor, the computer readable medium comprising:
program instructions that invoke a signal routing application in an application layer to detect validity of data of each signal of the message transferred from a CAN driver and route data of a valid signal, in the case of performing signal routing on the message received through the vehicle network;
program instructions that detect validity of data of the message transferred from the CAN driver and filtering valid data to route valid of the message, in the case of performing message routing on the message received through the vehicle network; and
program instructions that invoke a diagnosis application in the application layer to authenticate the access of the diagnosing apparatus and process data of the authenticated diagnosing apparatus at the time of an access of a diagnosing apparatus through the diagnosing CAN positioned inside the vehicle.
